(19) United States
(12) Patent Application Publication
(10) Pub. No.: US 2014/0015844 A1
(43) Pub. Date: Jan. 16, 2014

(54) IMAGE PROCESSING METHOD AND ELECTRONIC DEVICE

(71) Applicants: Lenovo (Beijing) Co., Ltd., Beijing (CN); Beijing Lenovo Software Ltd, Beijing (CN)

(72) Inventor: Qian Zhao, Beijing (CN)

(21) Appl. No.: 13/937,722

(22) Filed: Jul. 9, 2013

(30) Foreign Application Priority Data
Jul. 16, 2012 (CN) 201210246508.0

(51) Int. Cl. G06T 3/00

(52) U.S. Cl. CPC G06T 3/0056
USPC 345/581

(57) ABSTRACT

The invention discloses an image processing method applied to an electronic device having a changeable shape, the method includes: determining image information that is currently required to be processed; collecting shape change information of the electronic device; processing the image information in accordance with the shape change information; and displaying the processed image information on a display unit of the electronic device. In the image processing method disclosed by the present invention, the change of image information is achieved by change in shape of the electronic device, without the need to perform a menu operation of electronic device, and the problem in the prior art that the operation process for achieving the change of image contour by means of a menu operation is cumbersome and inconvenient to use is solved.

This application claims priority to Chinese patent application No. 201210246508.0 titled “IMAGE PROCESSING METHOD AND ELECTRONIC DEVICE” and filed with the State Intellectual Property Office on Jul. 16, 2012, which is incorporated herein by reference in its entirety.

### FIELD OF THE INVENTION

The invention relates to the field of image processing technology, and more particularly to an image processing method and an electronic device.

### BACKGROUND OF THE INVENTION

In the prior art, when in a shooting preview mode, an electronic device can achieve the change of image contour by means of a menu operation, resulting in a magic mirror effect.

However, this method, which achieves the change of image contour by means of a menu operation, requires a user to perform key pressing operations to the electronic device frequently, the process is cumbersome and inconvenient to use.

### SUMMARY OF THE INVENTION

In view of this, the invention provides an image processing method and an electronic device, which can solve the problem in the prior art that the operation process for achieving the change of image contour by means of a menu operation is cumbersome and inconvenient to use.

To achieve the above object, a solution proposed herein is as follows.

An image processing method applied to an electronic device having a changeable shape, the method includes:

determining image information that is currently required to be processed;

collecting shape change information of the electronic device;

processing the image information in accordance with the shape change information; and

displaying the processed image information on a display unit of the electronic device.

Preferably, the determining image information that is currently required to be processed includes: collecting external image information.

Preferably the determining image information that is currently required to be processed includes: acquiring pre-stored image information.

Preferably, the collecting shape change information of the electronic device includes:

detecting change in shape of a display screen of the electronic device; and

generating shape change information according to the change in shape of the display screen of the electronic device.

Preferably, the collecting shape change information of the electronic device includes:

detecting change in shape of a shell of the electronic device;

generating shape change information according to the change in shape of the shell of the electronic device.

Preferably, processing the image information in accordance with the shape change information includes:

in the case that the electronic device protrudes outward, stretching the image information in a lateral direction and/or a longitudinal direction.

Preferably, the processing the image information in accordance with the shape change information specifically includes:

in the case that the electronic device recesses inward, shortening the image information in a lateral direction and/or a longitudinal direction.

Preferably, the processing the image information in accordance with the shape change information includes:

in the case that the electronic device protrudes outward, shortening the image information in a lateral direction and/or a longitudinal direction.

Preferably, the processing the image information in accordance with the shape change information includes:

in the case that the electronic device recesses inward, stretching the image information in a lateral direction and/or a longitudinal direction.

Preferably, the electronic device protruding outward includes: the display screen of the electronic device protruding outward and/or the shell of the electronic device protruding outward.

Preferably, the electronic device recessing inward includes: the display screen of the electronic device recessing inward and/or the shell of the electronic device recessing inward.

An electronic device having a changeable shape, comprising:

an image information determination unit, adapted to determine image information that is currently required to be processed;

a collecting unit, adapted to collect shape change information of the electronic device;

a processing unit, adapted to process the image information in accordance with the shape change information; and

a display unit, adapted to display the processed image information.

Preferably, the image information determination unit is an image information collecting unit adapted to collect external image information.

Preferably, the image information determination unit is an image information acquiring unit adapted to acquire pre-stored image information.

Preferably, the shape of a display screen of the electronic device is changeable, and the collecting unit includes:

a first detection unit, adapted to detect change in shape of the display screen of the electronic device; and

a first generation unit, adapted to generate shape change information according to the change in shape of the display screen of the electronic device.

Preferably, the shape of a shell of the electronic device is changeable, and the collecting unit includes:

a second detection unit, adapted to detect change in shape of the shell of the electronic device; and

a second generation unit, adapted to generate shape change information according to the change in shape of the shell of the electronic device.

From the technical solution described above, in the image processing method disclosed in the invention, the change of the image information is achieved by changing the shape of the electronic device, without the need of performing a menu operation of the electronic device anymore, which solves the problem in the prior art that the operation process for achieving the change of image contour by means of a menu operation is cumbersome and inconvenient to use.

### BRIEF DESCRIPTION OF THE DRAWINGS

In order to illustrate the technical solution in the embodiments of the invention and in the prior art more clear, drawings to be used in the descriptions of the embodiments or the prior art will be introduced below. Apparently, the drawings in the descriptions below are only a part of embodiments of the invention, and those skilled in the prior art can also obtain other drawings from these drawings without any creative works.

FIG. 1 is a flow chart of an image processing method disclosed by an embodiment of the invention;

FIG. 2 is a flow chart of an image processing method disclosed by another embodiment of the invention;

FIG. 3 is a flow chart of an image processing method disclosed by still another embodiment of the invention; and

FIG. 4 is a structural diagram of an electronic device disclosed by an embodiment of the invention.

### DETAILED DESCRIPTION OF THE INVENTION

The technical solution in the embodiments of the invention will be described clearly and completely hereinafter in conjunction with the drawings in the embodiments of the invention. Apparently, the embodiments described are only a part of embodiments of the invention, rather than all embodiments. All other embodiments obtained based on the embodiments in the invention by those skilled in the prior art without any creative works belong to the scope of protection of the invention.

An embodiment of the invention provides an image processing method and an electronic device, so as to solve the problem in the prior art that the operation process for achieving the change of image contour by means of a menu operation is cumbersome and inconvenient to use.

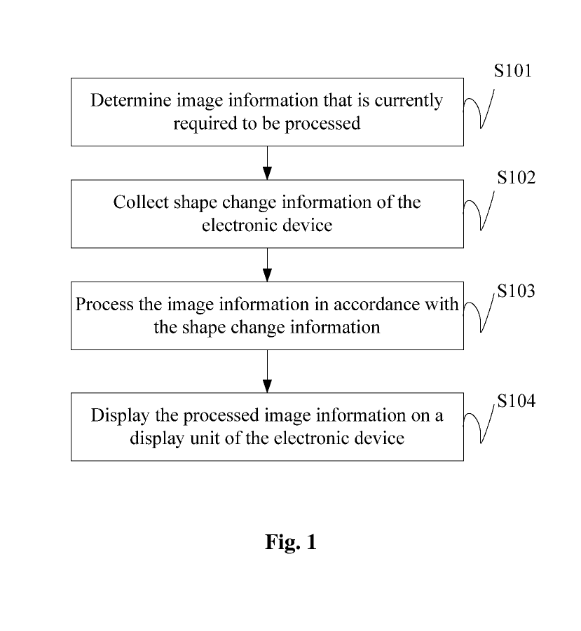

Specifically, the image processing method disclosed in the embodiment of the invention is applied to an electronic device having a changeable shape. As shown in FIG. 1, the image processing method includes the following steps:

step S101, determining image information that is currently required to be processed;

step S102, collecting shape change information of the electronic device;

step S103, processing the image information in accordance with the shape change information; and

step S104, displaying the processed image information on a display unit of the electronic device.

In the image processing method disclosed in the embodiment, the change of the image information is achieved by changing the shape of the electronic device, without the need of performing a menu operation of the electronic device anymore, which solves the problem in the prior art that the operation process during achieving the change of image contour by means of menu operations is cumbersome and inconvenient to use.

Specifically, the image information described in the embodiment refers to the information for determining the display contour of the image. By changing the image information, the change of the display contour of the image can be achieved. And the image information disclosed in the embodiment includes all information that can determine the display contour of the image, and those skilled in the art should know all the information that can determine the display contour of the image.

In the above embodiment, the step S101 of determining image information that is currently required to be processed may include: collecting external image information. Specifically, when the electronic device is in a shooting mode, an image information collecting unit of the electronic device, which may be a camera, collects the external image information; then, the shape change information of the electronic device is collected after the user operates the electronic device manually to make the shape of the electronic device change, and then the image information is processed in accordance with the shape change information; and the processed image information is displayed on a display unit of the electronic device, and at this time, the user can view the change of display contour of the image by viewing the display unit of the electronic device.

When the external image collected by the electronic device is image information of a self-portrait of the user, by the image processing method disclosed by the embodiment, the user can view the change of display contour of the self-portrait by changing manually the shape of the electronic device, as if the user is viewing a magic minor.

Of course, the step S101 of determining image information that is currently required to be processed may also include: acquiring pre-stored image information. In this case, the display contour of the image pre-stored can be changed using the image processing method disclosed in the embodiment.

The shape of the electronic device to which the image processing method disclosed in the above embodiment of the invention is applied is changeable. In general, the display screen of the electronic device adopts a flexible display screen, and the shell of the electronic device is made of materials that have high elasticity and can achieve shape changes.

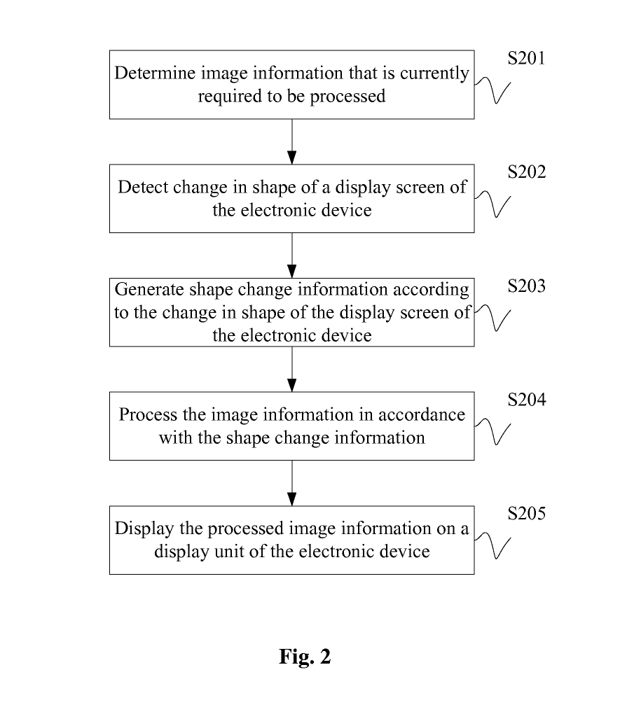

According to different shape change information of the collecting electronic device, the invention discloses two embodiments, and one of the two embodiments discloses an image processing method, as shown in FIG. 2, which includes the following steps.

Step S201, determining image information that is currently required to be processed.

Specifically, for the specific implementation form of this step, one can refer to the contents disclosed in the embodiment above.

Step S202, detecting change in shape of a display screen of the electronic device.

Specifically, in this step, the change in shape of the display screen may be detected by a sensor, but without the limitation of being detected by the sensor.

Step S203, generating shape change information according to the change in shape of the display screen of the electronic device.

Step S204, processing the image information in accordance with the shape change information.

Step S205, displaying the processed image information on a display unit of the electronic device.

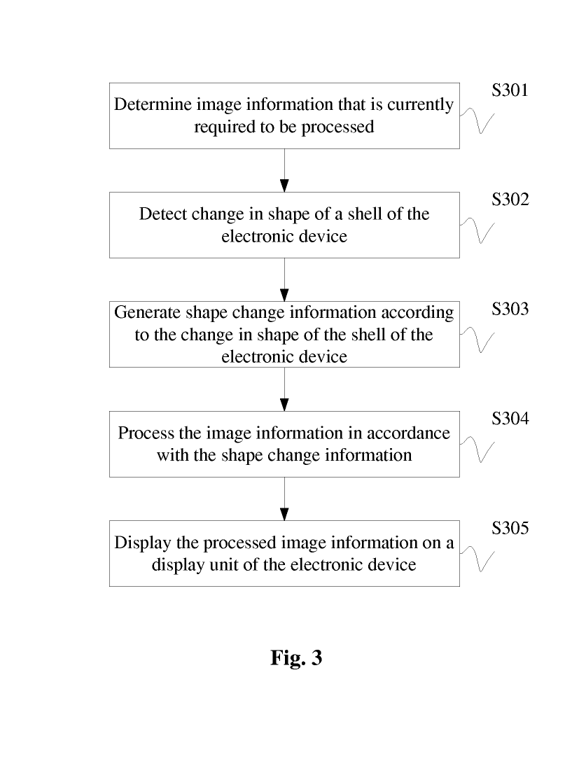

An image processing method disclosed by another embodiment of the invention, as shown in FIG. 3, includes the following steps.

Step S301, determining image information that is currently required to be processed.

For the specific implementation form of this step, one can refer to the contents described above, which will not be described in detail herein.

Step S302, detecting change in shape of a shell of the electronic device.

Specifically, in this step, the change of the shell of the electronic device is detected by a device such as a sensor.

Step S303, generating shape change information according to the change in shape of the shell of the electronic device.

Step S304, processing the image information in accordance with the shape change information.

Step S305, displaying the processed image information on a display unit of the electronic device.

Of course, when detecting the change in shape of the electronic device, the change in shape of the display screen of the electronic device and the change in shape of the shell of the electronic device can be simultaneously detected, and if it is detected that there is change in shape of the display screen and the shell of the electronic device, the shape change information can be generated according to the change in shape of the display screen and the shell of the electronic device.

In the image processing method disclosed in the embodiment of the invention described above, the processing the image information in accordance with the shape change information may include:

in the case that the electronic device protrudes outward, stretching the image information in a lateral direction and/or a longitudinal direction.

Specifically, when the display screen of the electronic device protrudes outward, the image information is stretched in a lateral direction and/or a longitudinal direction; or when the shell of the electronic device protrudes outward, the image information is stretched in a lateral direction and/or a longitudinal direction; or, when the shell of the electronic device protrudes outward and the display screen of the electronic device also protrudes outward, the image information is stretched in a lateral direction and/or a longitudinal direction.

The processing the image information in accordance with the shape change information may also include: in the case where the electronic device recesses inward, shortening the image information in a lateral direction and/or a longitudinal direction.

Similarly, when the display screen of the electronic device recesses inward, the image information is shortened in a lateral direction and/or a longitudinal direction; or when the shell of the electronic device recesses inward, the image information is shortened in a lateral direction and/or a longitudinal direction; or when the shell of the electronic device recesses inward and the display screen of the electronic device also recesses inward, the image information is shortened in a lateral direction and/or a longitudinal direction.

The processing the image information in accordance with the shape change information may also include: in the case where the electronic device protrudes outward, shortening the image information in a lateral direction and/or a longitudinal direction.

Specifically, when the display screen of the electronic device protrudes outward, the image information is shortened in a lateral direction and/or a longitudinal direction; or when the shell of the electronic device protrudes outward, the image information is shortened in a lateral direction and/or a longitudinal direction; or when the shell of the electronic device protrudes outward and the display screen of the electronic device protrudes outward, the image information is shortened in a lateral direction and/or a longitudinal direction.

The processing the image information in accordance with the shape change information may also include: in the case where the electronic device recesses inward, stretching the image information in a lateral direction and/or a longitudinal direction.

Specifically, when the display screen of the electronic device recesses inward, the image information is stretched in a lateral direction and/or a longitudinal direction; or when the shell of the electronic device recesses inward, the image information is stretched in a lateral direction and/or a longitudinal direction; or when the shell of the electronic device recesses inward and the display screen of the electronic device also recesses inward, the image information is stretched in a lateral direction and/or a longitudinal direction.

The contents above are only some implementation forms of processing the image information in accordance with the shape change information. Of course, for different shape change information of the electronic device, different processing is made to the image information. It may be the following situations: the shape change information of the electronic device is the same as the image information processing method, specifically, when the shape of the electronic device changes, the image displayed after the image information processing is the same as the shape presented by the electronic device the shape of which has changed; or the shape change information of the electronic device is opposite to the image information processing method, specifically, when the shape of the electronic device changes, the image displayed after the image information processing is opposite to the shape presented by the electronic device the shape of which has changed.

Furthermore, the corresponding relationship between the shape change information and the image information processing method of the electronic device can be determined according to a setting of the user, and when the shape of the electronic device is changed, the image information is processed in accordance with the set corresponding relationship.

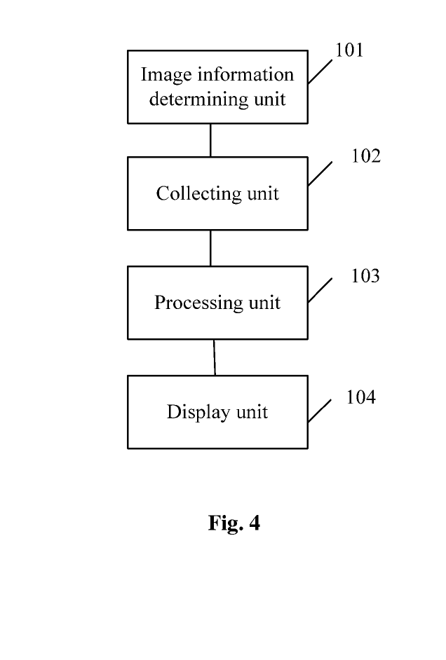

Another embodiment of the invention also discloses another electronic device. The electronic device disclosed by the invention may include a mobile phone and a tablet computer and the like that have been used by users nowadays, and the shapes of these electronic devices are changeable. As shown in FIG. 4, the electronic device described includes:

an image information determination unit 101, adapted to determine image information that is currently required to be processed;

a collecting unit 102, adapted to collect shape change information of the electronic device;

a processing unit 103, adapted to process the image information in accordance with the shape change information; and

a display unit 104, adapted to display the processed image information.

Specifically, the image information determination unit 101 determines the image information that is currently required to be processed; when the shape of the electronic device changes, the collecting unit 102 collects the shape change information of the electronic device; the processing unit 103 processes the image information in accordance with the shape change information; and finally the display unit 104 displays the processed image information.

In the electronic device disclosed in the embodiment, the change of the image information is achieved by changing the shape of the electronic device, without the need of performing a menu operation of the electronic device, which solves the problem in the prior art that the operation process during achieving the change of image contour by means of a menu operation is cumbersome and inconvenient to use.

Specifically, the image information determination unit 101 in the electronic device may be an image information collecting unit adapted to collect external image information. In general, the image information collecting unit is a camera disposed on the electronic device, and the camera directly collects the external image information and transmits the collected external image information to the processing unit 103.

Or, the image information determination unit 101 is an image information acquiring unit adapted to acquire pre-stored image information. There are images stored in a storage device of the electronic device, and the image information in the storage device can be acquired by the image information acquiring unit and then is transmitted to the processing unit 103.

Furthermore, the collecting unit 102 of the electronic device disclosed in the embodiment described above may include:

a first detection unit, adapted to detect change in shape of the display screen of the electronic device; and

a first generation unit, adapted to generate shape change information according to the change in shape of the display screen of the electronic device.

Specifically, the first detection unit may be a sensor disposed on the electronic device, which may detect the change in shape of the display screen of the electronic device, and transmit the change in shape of the display screen of the electronic device to the first generation unit, and the first generation unit can generate the shape change information according to the change in shape of the display screen of the electronic device.

Or, the collection unit 102 of the electronic device disclosed in the embodiment described above may also include:

a second detection unit, adapted to detect change in shape of the shell of the electronic device; and

a second generation unit, adapted to generate shape change information according to the change in shape of the shell of the electronic device.

Similarly, the second detection unit may be a sensor disposed on the electronic device, which may detect the change in shape of the shell of the electronic device, and transmit the change in shape of the display screen of the electronic device to the second generation unit, and the second generation unit can also generate shape change information according to the change in shape of the display screen of the electronic device.

The first detection unit and the second detection unit disclosed in the embodiment may be a same detection unit which can detect the change in shape of the shell of the electronic device or the change in shape of the display screen of the electronic device. Of course, the first detection unit and the second detection unit may also be separate detection units.

Similarly, the first generation unit and the second generation unit disclosed in the embodiment may be a same generation unit which can generate shape change information according to the change in shape of the display screen of the electronic device and can also generate shape change information according to the change in shape of the shell of the electronic device. Of course, the first generation unit and the second generation unit may also be separate generation units.

Specifically, the processing the image information by the processing unit 103 according to the shape change information that is disclosed in the embodiment described above may include:

in the case where the electronic device protrudes outward, stretching the image information in a lateral direction and/or a longitudinal direction.

Specifically, when the display screen of the electronic device protrudes outward, the image information is stretched in a lateral direction and/or a longitudinal direction; or when the shell of the electronic device protrudes outward, the image information is stretched in a lateral direction and/or a longitudinal direction; or when the shell of the electronic device shell protrudes outward and the display screen of the electronic device also protrudes outward, the image information is stretched in a lateral direction and/or a longitudinal direction.

The processing the image information by the processing unit 103 in accordance with the shape change information may also include: in the case where the electronic device recesses inward, shortening the image information in a lateral direction and/or a longitudinal direction.

Similarly, when the display screen of the electronic device recesses inward, the image information is shortened in a lateral direction and/or a longitudinal direction; or when the shell of the electronic device recesses inward, the image information is shortened in a lateral direction and/or a longitudinal direction; or when the shell of the electronic device recesses inward and the display screen of the electronic device recesses inward, the image information is shortened in a lateral direction and/or a longitudinal direction.

The processing the image information by the processing unit 103 in accordance with the shape change information may also include: in the case where the electronic device protrudes outward, shortening the image information in a lateral direction and/or a longitudinal direction.

Specifically, when the display screen of the electronic device protrudes outward, the image information is shortened in a lateral direction and/or a longitudinal direction; or when the shell of the electronic device protrudes outward, the image information is shortened in a lateral direction and/or a longitudinal direction; or when the shell of the electronic device protrudes outward and the display screen of the electronic device also protrudes outward, the image information is shortened in a lateral direction and/or a longitudinal direction.

The processing the image information by the processing unit 103 in accordance with the shape change information may also include: in the case where the electronic device recesses inward, stretching the image information in a lateral direction and/or a longitudinal direction.

Specifically, when the display screen of the electronic device recesses inward, the image information is stretched in a lateral direction and/or a longitudinal direction; or when the shell of the electronic device recesses inward, the image information is stretched in a lateral direction and/or a longitudinal direction; or when the shell of the electronic device recesses inward and the display screen of the electronic device also recesses inward, the image information is stretched in a lateral direction and/or a longitudinal direction.

The specific working processes of the various units disclosed in the electronic device embodiments of the invention are the same as that in the method embodiments, and one can refer to the contents disclosed in the method embodiments, which will not be described in detail herein.

Finally, it should be noted that, relation terms herein, such as “a first” and “a second”, are used only to distinguish an entity or operation from another entity or operation, without necessarily requiring or implying that there is any actual relation or sequence between these entities or operations. Moreover, the terms “comprise”, “include” or any other variants thereof are intended to cover a non-exclusive inclusion, such that the process, method, article, or device including a series of elements includes not only these elements, but also other elements that are not explicitly listed, or also includes inherent elements of such process, method, article or device. In the case where there are no more limitations, an element which is defined by a statement “include a” does not exclude that in the process, method, article, or device including the element there is a same element other than the element.

The embodiments of the invention are described herein in a progressive manner, with the emphasis for illustration of each embodiment is placed on the difference between the embodiment and the other embodiments; hence, for the same or similar parts between the embodiments, one can refer to the other embodiments.

The description of the embodiments herein enables those skilled in the art to implement or use the invention. Numerous modifications to the embodiments will be apparent to those skilled in the art, and the general principle herein can be implemented in other embodiments without deviation from the spirit or scope of the invention. Therefore, the invention will not be limited to the embodiments described herein, but in accordance with the widest scope consistent with the principle and novel features disclosed herein.

1. An image processing method applied to an electronic device having a changeable shape, comprising:
determining image information that is currently required to be processed;
collecting shape change information of the electronic device;
processing the image information in accordance with the shape change information; and
displaying the processed image information on a display unit of the electronic device.

2. The method according to claim 1, wherein the determining image information that is currently required to be processed comprises: collecting external image information.

3. The method according to claim 1, wherein the determining image information that is currently required to be processed comprises: acquiring pre-stored image information.

4. The method according to claim 1, wherein the collecting shape change information of the electronic device comprises:
detecting change in shape of a display screen of the electronic device; and
generating shape change information according to the change in shape of the display screen of the electronic device.

5. The method according to claim 2, wherein the collecting shape change information of the electronic device comprises:
detecting change in shape of a display screen of the electronic device; and
generating shape change information according to the change in shape of the display screen of the electronic device.

6. The method according to claim 3, wherein the collecting shape change information of the electronic device comprises:
detecting change in shape of a display screen of the electronic device; and
generating shape change information according to the change in shape of the display screen of the electronic device.

7. The method according to claim 1, wherein the processing the image information in accordance with the shape change information comprises:
in the case that the electronic device protrudes outward, stretching the image information in a lateral direction and/or a longitudinal direction.

8. The method according to claim 1, wherein the processing the image information in accordance with the shape change information comprises:
in the case that the electronic device recesses inward, shortening the image information in a lateral direction and/or a longitudinal direction.

9. The method according to claim 1, wherein the processing the image information in accordance with the shape change information comprises:
in the case that the electronic device protrudes outward, shortening the image information in a lateral direction and/or a longitudinal direction.

10. The method according to claim 1, wherein the processing the image information in accordance with the shape change information comprises:
in the case that the electronic device recesses inward, stretching the image information in a lateral direction and/or a longitudinal direction.

11. The method according to claim 7, wherein the electronic device protruding outward comprises: the display screen of the electronic device protruding outward and/or the shell of the electronic device protruding outward.

12. The method according to claim 9, wherein the electronic device protruding outward comprises: the display screen of the electronic device protruding outward and/or the shell of the electronic device protruding outward.

13. The method according to claim 8, wherein the electronic device recessing inward comprises: the display screen of the electronic device recessing inward and/or the shell of the electronic device recessing inward.

14. The method according to claim 10, wherein the electronic device recessing inward comprises: the display screen of the electronic device recessing inward and/or the shell of the electronic device recessing inward.

15. An electronic device having a changeable shape, comprising:
an image information determination unit, adapted to determine image information that is currently required to be processed;
a collecting unit, adapted to collect shape change information of the electronic device;
a processing unit, adapted to process the image information in accordance with the shape change information; and
a display unit, adapted to display the processed image information.

16. The electronic device according to claim 15, wherein the image information determination unit is an image information collecting unit adapted to collect external image information.

17. The electronic device according to claim 15, wherein the image information determination unit is an image information acquiring unit adapted to acquire pre-stored image information.

18. The electronic device according to claim 15, wherein the shape of a display screen of the electronic device is changeable, and the collecting unit comprises:
a first detection unit, adapted to detect change in shape of the display screen of the electronic device; and
a first generation unit, adapted to generate shape change information according to the change in shape of the display screen of the electronic device.

19. The electronic device according to claim 16, wherein the shape of a display screen of the electronic device is changeable, and the collecting unit comprises:
a first detection unit, adapted to detect change in shape of the display screen of the electronic device; and
a first generation unit, adapted to generate shape change information according to the change in shape of the display screen of the electronic device.

20. The electronic device according to claim 15, wherein the shape of a shell of the electronic device is changeable, and the collecting unit comprises:
a second detection unit, adapted to detect change in shape of the shell of the electronic device; and
a second generation unit, adapted to generate shape change information according to the change in shape of the shell of the electronic device.
